(19) United States
(12) Patent Application Publication
(10) Pub. No.: US 2016/0117035 A1
(43) Pub. Date: Apr. 28, 2016

(54) Pressure Detection Device and Input Device

(71) Applicant: NISSHA PRINTING CO., LTD., Kyoto (JP)

(72) Inventors: Yuji Watazu, Kyoto-shi (JP); Eiji Kakutani, Kyoto-shi (JP); Keisuke Ozaki, Kyoto-shi (JP); Junichi Shibata, Kyoto-shi (JP)

(73) Assignee: Nissha Printing, Co., Ltd., Kyoto-shi (JP)

(21) Appl. No.: 14/895,687

(22) PCT Filed: May 22, 2014
(86) PCT No.: PCT/JP2014/063563

§ 371 Date: Dec. 3, 2015

(30) Foreign Application Priority Data
Jun. 5, 2013 (JP) 2013-119344
Jun. 5, 2013 (JP) 2013-119345

(51) Int. Cl. G06F 3/041; G01L 1/16; G01L 1/14

(52) U.S. Cl. CPC G06F 3/0414; G01L 1/142; G01L 1/16; G06F 2203/04105

(57) ABSTRACT

A piezoelectric sensor capable of position detection and load detection within the sensor. The sensor includes a piezoelectric layer that generates an electric charge when pressed by an inputting means, a first electrode that is arranged on a first main face of the piezoelectric layer, a second electrode that is arranged on a second main face of the piezoelectric layer opposite the first main face, a first capacitor or a first resonant circuit connected to the first electrode, and a first detection section connected to the first electrode.

### TECHNICAL FIELD

The present invention relates to a piezoelectric sensor that generates a piezoelectric signal according to a load, more particularly, to a piezoelectric sensor capable of detecting a position at which a load is applied.

### BACKGROUND ART

For detecting an applied load, a piezoelectric sensor using a piezoelectric sheet is known. For instance, Patent Document 1 discloses a transparent piezoelectric sensor comprised of a transparent pressure-sensitive layer and a pair of transparent conductive layers.

### PRIOR ART DOCUMENTS

Patent Document 1: Japanese Unexamined Patent Application Publication No. 2004-125571

### SUMMARY

### Problem to be Solved by Invention

However, with the transparent piezoelectric sensor of Patent Document 1, the electric charge generated from the piezoelectric sheet is so small that it is difficult to detect this electric charge generated from the piezoelectric sheet.

### Solution

For accomplishing the above-noted object, the present invention configures as follows.

A pressure detection device according to the present invention comprises:

a piezoelectric layer that generates an electric charge when pressed by an inputting means;

a first electrode that is arranged on a first main face of the piezoelectric layer;

a second electrode that is arranged on a second main face of the piezoelectric layer opposite the first main face;

a first capacitor connected to the first electrode; and

a first detection section connected to the first electrode and the first capacitor.

A pressure detection device according to the present invention comprises:

a piezoelectric layer that generates an electric charge when pressed by an inputting means;

a first electrode that is arranged on a first main face of the piezoelectric layer;

a second electrode that is arranged on a second main face of the piezoelectric layer opposite the first main face;

a first capacitor connected to the first electrode;

a first multiplexer connected to the first electrode and the first capacitor;

a first detection section connected to the first multiplexer;

wherein the first electrode includes a plurality of first electrode sections connected to the first capacitor; and

the first multiplexer is configured to selectively connect the plurality of the first electrode sections to the first detection section.

A pressure detection device according to the present invention comprises:

a piezoelectric layer that generates an electric charge when pressed by an inputting means;

a first electrode that is arranged on a first main face of the piezoelectric layer;

a first capacitor connected to the first electrode;

a first multiplexer connected to the first electrode and the first capacitor;

a first detection section connected to the first multiplexer;

a second electrode that is arranged on a second main face of the piezoelectric layer opposite the first main face;

a second capacitor connected to the second electrode;

a second multiplexer connected to the second electrode and the second capacitor;

a second detection section connected to the second multiplexer;

wherein the first electrode includes a plurality of first electrode sections connected to the first capacitor; and

the first multiplexer is configured to selectively connect the plurality of the first electrode sections to the first detection section;

wherein the second electrode includes a plurality of second electrode sections connected to the second capacitor; and

the second multiplexer is configured to selectively connect the plurality of the second electrode sections to the second detection section.

According to one embodiment of the invention;

the first electrode sections are disposed in a direction parallel with one direction; and

the second electrode sections are disposed in a direction perpendicular to the one direction.

According to one embodiment of the invention;

the first detection section includes:
a first amplifier section connected to the first multiplexer; and
a first voltage detector connected to the first amplifier section.

According to one embodiment of the present invention:

the first detection section includes a first band-pass filter connected between the first amplifier section and the first voltage detector and having a frequency (f1) represented by a following formula (1),

f1=1/(T1×2) formula (1)

where T1=a period required from connection of the first detection section to one first electrode section to connection thereof to another first electrode section.

According to one embodiment of the invention;

the second detection section includes:
a second amplifier section connected to the second multiplexer; and
a second voltage detector connected to the second amplifier section.

According to one embodiment of the present invention:

the second detection section includes a second band-pass filter connected between the second amplifier section and the second voltage detector and having a frequency (f2) represented by a following formula (2),

f2=1/(T2×2) formula (2)

where T2=a period required from connection of the second detection section to one second electrode section to connection thereof to another second electrode section.

A pressure detection device according to the present invention comprises:

a piezoelectric layer that generates an electric charge when pressed by an inputting means;

a first electrode that is arranged on a first main face of the piezoelectric layer;

a second electrode that is arranged on a second main face of the piezoelectric layer opposite the first main face;

a first resonant circuit connected to the first electrode; and

a first detection section connected to the first electrode and the first resonant circuit.

A pressure detection device according to the present invention comprises:

a piezoelectric layer that generates an electric charge when pressed by an inputting means;

a first electrode that is arranged on a first main face of the piezoelectric layer;

a second electrode that is arranged on a second main face of the piezoelectric layer opposite the first main face;

a first resonant circuit connected to the first electrode;

a first multiplexer connected to the first electrode and the first resonant circuit;

a first detection section connected to the first multiplexer;

wherein the first electrode includes a plurality of first electrode sections connected to the first resonant circuit; and

the first multiplexer is configured to selectively connect the plurality of the first electrode sections to the first detection section.

A pressure detection device according to the present invention comprises:

a piezoelectric layer that generates an electric charge when pressed by an inputting means;

a first electrode that is arranged on a first main face of the piezoelectric layer;

a first resonant circuit connected to the first electrode;

a first multiplexer connected to the first electrode and the first resonant circuit;

a first detection section connected to the first multiplexer;

a second electrode that is arranged on a second main face of the piezoelectric layer opposite the first main face;

a second resonant circuit connected to the second electrode;

a second multiplexer connected to the second electrode and the second resonant circuit;

a second detection section connected to the second multiplexer;

wherein the first electrode includes a plurality of first electrode sections connected to the first resonant circuit;

the first multiplexer is configured to selectively connect the plurality of the first electrode sections to the first detection section;

wherein the second electrode includes a plurality of second electrode sections connected to the second resonant circuit; and

the second multiplexer is configured to selectively connect the plurality of the second electrode sections to the second detection section.

According to one embodiment of the invention;

the first electrode sections are disposed in a direction parallel with one direction; and

the second electrode sections are disposed in a direction perpendicular to the one direction.

According to one embodiment comprising the resonant circuit of the invention;

the resonant circuit includes a variable capacitance diode.

According to one embodiment of the present invention, the embodiment comprises the above-described pressure detection device and a touch panel.

### Effects of the Invention

The piezoelectric sensor according to the present invention can detect an electric charge generated from a piezoelectric sheet even when this electric charge generated from the piezoelectric sheet is very small.

### BRIEF DESCRIPTION OF THE DRAWINGS

FIG. 1 is a conceptual diagram of a pressure detection device,

FIG. 2 is a conceptual diagram of a pressure detection device,

FIG. 3 is a section view taken along A-A′ in FIG. 2 (FIG. 8),

FIG. 4 is a conceptual diagram of a pressure detection device,

FIG. 5 is a conceptual diagram of a pressure detection device,

FIG. 6 is a conceptual diagram of a pressure detection device,

FIG. 7 is a conceptual diagram of a pressure detection device,

FIG. 8 is a conceptual diagram of a pressure detection device,

FIG. 9 is a conceptual diagram of a pressure detection device, and

FIG. 10 is a section view showing variation of a piezoelectric sensor.

### EMBODIMENTS OF THE INVENTION

Next, embodiments of the present invention will be explained in greater details with reference to the accompanying drawings. Unless indicted expressly otherwise, all dimensions, materials, shapes and their relative positions of sections, portions described in the embodiments of the present invention are not intended to be limiting the scope of the invention thereto, but being merely provided for the explanation purpose.

### 1. First Embodiment

### (1) General Configuration of Pressure Detection Device

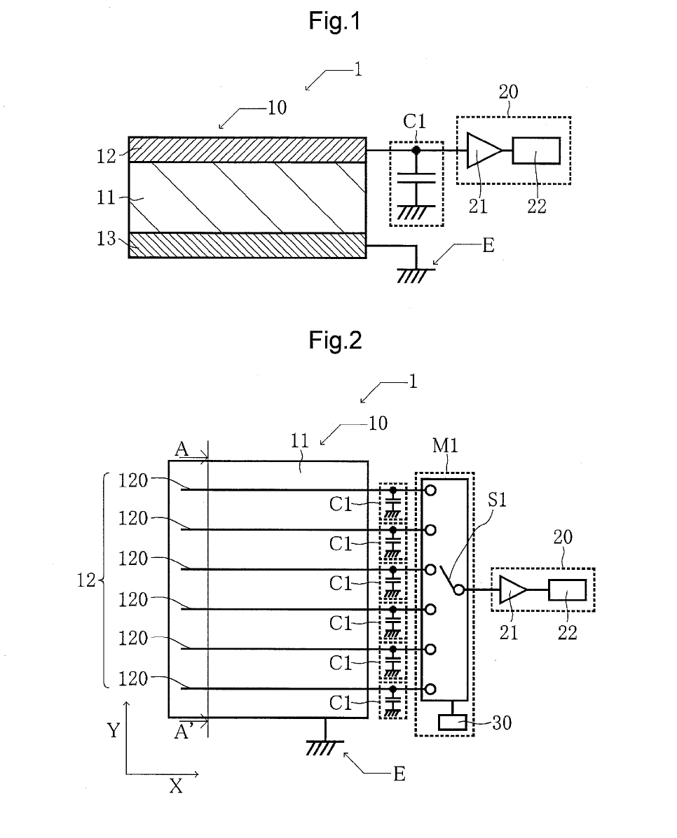

With reference to FIG. 1, there will be explained a general configuration of a pressure detection device relating to a first embodiment of the present invention. FIG. 1 is a schematic showing of a pressure detection device.

The pressure detection device has a function of detecting an amount and a position of a load applied thereto.

As shown in FIG. 1, the pressure detection device 1 relating to the first embodiment includes a piezoelectric sensor 10, a first detection section 20 and a first capacitor C1. The piezoelectric sensor 10 includes a piezoelectric layer 11, a first electrode 12 and a second electrode 13. The first electrode 12 is disposed on a first main face of the piezoelectric layer 11 and is electrically connected to the first capacitor C1. The second electrode 13 is disposed on a second main face of the piezoelectric sheet 11 opposite the first main face and is electrically connected to a ground E. Incidentally, the first electrode 12 and the second electrode 13 are respectively disposed on the entire face of the piezoelectric layer 11.

Next, respective features of the pressure detection device 1 will be explained in details.

### (2) Piezoelectric Sensor

The piezoelectric sensor 10 is a device configured to generate an electric charge according to a load applied thereto. As shown in FIG. 1, the piezoelectric sensor 10 includes the piezoelectric layer 11, the first electrode 12 and the second electrode 13.

### (3) Piezoelectric Layer

As some examples of material forming the piezoelectric layer 11, an inorganic piezoelectric material and an organic piezoelectric material can be cited.

As some examples of the inorganic piezoelectric material, barium titanate, lead titanate, lead zirconate titanate, potassium niobate, lithium niobate, lithium tantalate, etc. can be cited.

As some examples of the organic piezoelectric material, fluoride polymers or copolymers thereof, polymer materials having chirality, etc. can be cited. As some examples of fluoride polymers or copolymers thereof, polyvinylidene fluoride, vinylidene fluoride-tetrafluoroetheylene copolymer, vinylidene fluoride-trifluoroethylene copolymer, etc. can be cited. As some examples of polymer material having chirality, L-polylactic acid, R-polylactic acid, etc. can be cited.

Further, in case the pressure detection device 1 is to be disposed on a display device such as a liquid crystal display, it is preferred that the piezoelectric sheet be formed of a transparent material or be formed thin to enable sufficient light transmission therethrough.

### (4) Electrodes

The first electrode 12 and the second electrode 13 as described above can be formed of a material having electric conductivity. As some examples of material having electric conductivity, transparent conductive oxidized materials such as indium-tin-oxide (ITO), tin-zinc-oxide (TZO), conductive polymers such as polyethylenedioxy Thiophene (PEDOT), etc. can be used. In this case, the above-described electrodes can be formed with using vapor deposition, screen printing, etc.

Further, as material having conductivity, conductive metal such as copper, silver, etc. can be employed also. In this case, the above-described electrodes can be formed with using vapor deposition or using metal paste such as copper paste, silver paste, etc.

Further, as material having conductivity, it is possible to employ conductive material such as carbon nanotube, metal particles, metal nanofibers, etc. dispersed in a binder.

### (5) First Capacitor

The first capacitor C1 comprises an arrangement of a capacitor being grounded. The first capacitor C1 is a device that stores an electric charge by capacitance or discharges it. As examples of such material, a ceramic capacitor, a tantalum capacitor, a film capacitor can be cited.

Incidentally, preferably, electric charge stored in the first capacitor C1 should be removed from the first capacitor C1 when no load is applied to the piezoelectric sensor 10. For removing electric charge from the first capacitor C1, a discharging switch can be disposed between the piezoelectric sensor 10 and the first detection section 20.

### (6) Detection Section

The first detection section 20 is a device for detecting electric charge generated in the piezoelectric sensor 10. The first detection section 20 includes a first amplifier section 21 and a first potential detection section 22. The first amplifier section 21 is a device for amplifying a voltage of the first capacitor C1 generated with charging of electric charge and this device is connected to the first electrode 12 and the first capacitor C1. The first potential detection section 22 is a device for determining a potential of electric charge amplified by the first amplifier section 21 and this device is connected to the first amplifier section 21.

### (7) Effects

With the above-described configuration of the present invention, in the pressure detection device 1, the first electrode 12 is connected to the first capacitor C1. Therefore, electric charge generated in the piezoelectric layer 11 is stored in the first capacitor C1 via the first electrode 12. With this, even when electric charge generated when the piezoelectric layer 11 is pressed is small, through detection of the voltage of the first capacitor C1 by the first detection section 20, the electric charge generated as above can be detected by the first detection section 20.

Moreover, the first detection section 20 includes the first amplifier section 21 and the first potential detection section 22. Therefore, even if the voltage of the first capacitor C1 is small, after this voltage is amplified by the first amplifier section 21, this can be detected by the first potential detection section 22.

### 2. Second Embodiment

Next, a second embodiment of the present invention will be described. As its basic configuration is identical to that of the first embodiment, only differences thereof will be explained.

### (1) General Configuration of Pressure Detection Device

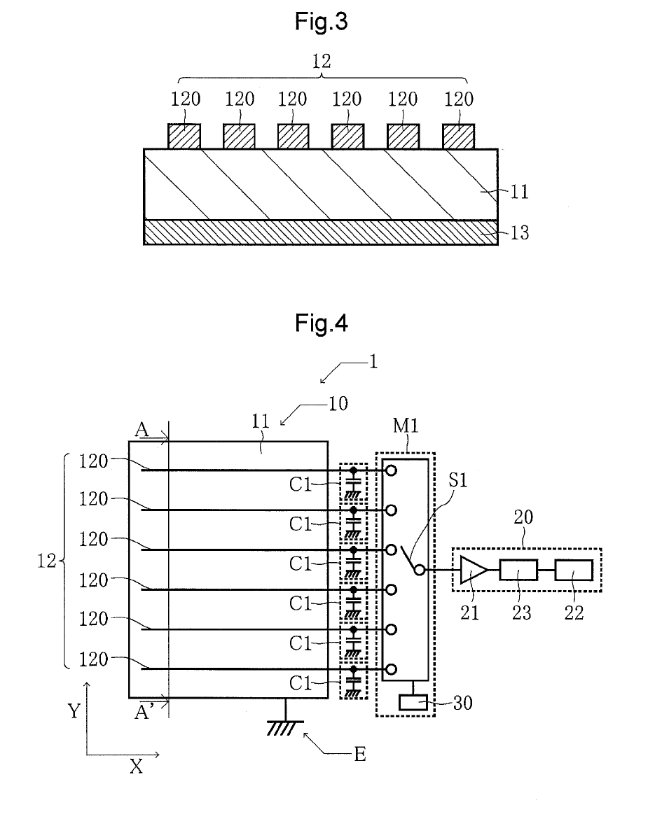

With reference to FIG. 2, a general configuration of a pressure detection device according to a second embodiment of the present invention will be described. FIG. 2 is a schematic showing the pressure detection device. FIG. 3 is a section taken along A-A′ in FIG. 2. FIG. 4 shows a variation of the second embodiment.

As shown in FIG. 2, the pressure detection device 1 according to the second embodiment includes a piezoelectric sensor 10, a first detection section 20, first capacitors C1 and a first multiplexer M1.

As shown in FIG. 3, the piezoelectric sensor 10 includes a piezoelectric layer 11, a first electrode 12 and a second electrode 13. The first electrode 12 is disposed on a first main face of the piezoelectric layer 11 and includes a plurality of first electrode sections 120. The first electrode sections 120 are disposed parallel with an Y-axis direction of the piezoelectric layer 11, with each section 120 being connected to the respective first capacitor C1.

Incidentally, the first electrode sections 120 and the first capacitors C1 are connected to the first detection section 20 via the first multiplexer M1.

The second electrode 13 is disposed on a second main face of the piezoelectric layer 11 opposite the first main face. The second electrode 13 is disposed on entire face of the second main face and is connected to the ground E.

### (2) Multiplexer

The first multiplexer M1 is a device configured to select one first electrode section 120 from the plurality of first electrode sections 120 and to connect the selected first electrode section 120 to the first detection section 20.

Incidentally, switching of the first electrode sections 120 can be realized by execution by a CPU of a program stored in a storage section such as a microcomputer or a custom IC, etc.

### (3) Detection Section

The first detection section 20 includes a first amplifier section 21 and a first potential detection section 22. The configurations of the first amplifier section 21 and the first potential detection section 22 are identical to those described above, so explanation thereof will be omitted.

### (4) Effects

With the above-described configuration of the present invention, in the pressure detection device 1, the first electrode 12 is connected to the first capacitor C1. Therefore, electric charge generated in the piezoelectric layer 11 is stored in the first capacitor C1 via the first electrode 12. With this, even when electric charge generated when the piezoelectric layer 11 is pressed is small, through detection of the voltage of the first capacitor C1 by the first detection section 20, the electric charge generated as above can be detected by the first detection section 20.

Moreover, the first detection section 20 includes the first amplifier section 21 and the first potential detection section 22. Therefore, even if the voltage of the first capacitor C1 is small, after this voltage is amplified by the first amplifier section 21, this can be detected by the first potential detection section 22.

Further, the first electrode 12 includes a plurality of first electrode sections 120 which are disposed parallel with the Y-axis direction. Also, the first electrode sections 120 are connected to the first detection section 20 via the first multiplexer M1.

Therefore, which one of the plurality of first electrode sections 120 the electric charge detected by the first detection section 20 has passed can be detected by the first multiplexer M1. Consequently, respecting a load applied to the piezoelectric sensor 10, position of the load in the Y-axis direction can be specified.

### (5) Variation

As shown in FIG. 4, in the pressure detection device 1, the first detection section 20 may include a first band-pass filter 23. This first band-pass filter 23 is disposed between the first amplifier section 21 and the first potential detection section 22. The first band-pass filter 23 can be comprised of an RLC circuit which passes only frequency of a predetermined range.

Incidentally, a frequency f1 of the first band-pass filter 23 is set as: 1/(T1×2). Where, the invariable: T1 denotes a period from connecting the first detection section 20 to one first electrode section 120 to connecting the same to another first electrode section 120 by the first multiplexer M1.

With the above-described configuration of the first detection section 20, as the first electrode sections 120 to be connected to the first detection section 20 are switched one after another in association with an operation of the first multiplexer M1, the voltage detected by the first potential detection section 22 will vary over time. In this voltage variation, the component of the frequency f1 (f1=1/(T1×2)) contains much voltage information of each first capacitor C1, whereas the other frequency component contains much noise. Here, this noise means such noise which can be received from the electromagnetic wave present around the piezoelectric sensor 10. Therefore, with detection of the frequency f1 alone by the first band-pass filter 23, noise can be removed effectively.

### 3. Third Embodiment

Next, a third embodiment of the present invention will be explained. As its basic configuration is identical to those of the first and second embodiments, only differences thereof will be explained.

### (1) General Configuration of Pressure Detection Device

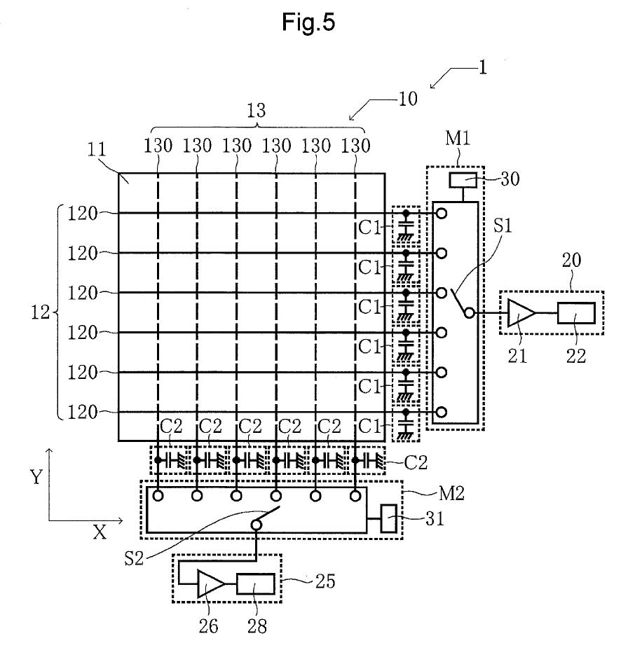

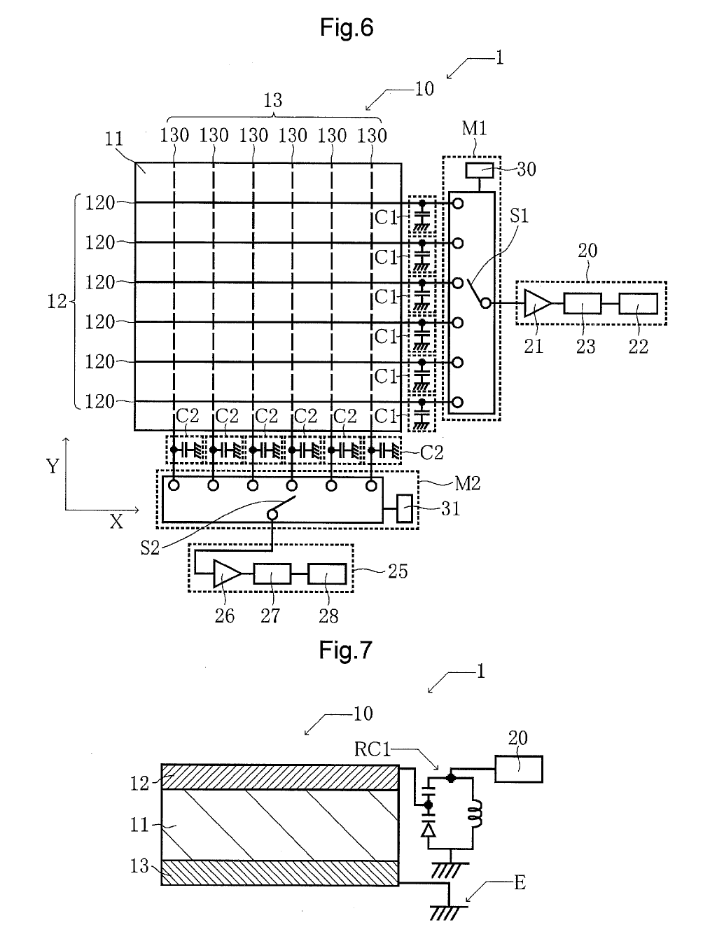

With reference to FIG. 5, a general configuration of a pressure detection device according to a third embodiment of the present invention will be explained. FIG. 5 is a schematic showing of the pressure detection device. FIG. 6 shows a variation of the third embodiment.

As shown in FIG. 5, the pressure detection device 1 according to the third embodiment includes a piezoelectric sensor 10, a first detection section 20, first capacitors C2, second capacitors C2, a first multiplexer M1 and a second multiplexer M2.

The piezoelectric sensor 10 includes a piezoelectric layer 11, a first electrode 12 and a second electrode 13. The first electrode 12 is disposed on a first main face of the piezoelectric layer 11 and includes a plurality of first electrodes sections 120. The first electrode sections 120 are arranged parallel with the Y-axis direction of the piezoelectric layer 11 and connected respectively to the first capacitors C1. Incidentally, the first electrode sections 120 and the first capacitors C1 are connected to the first detection section 20 via the first multiplexer M1.

The second electrode 13 is disposed on a second main face of the piezoelectric layer 11 opposite the first main face. The second electrode 13 includes a plurality of second electrode sections 130. These second electrode sections 130 are arranged parallel with the X-axis direction of the piezoelectric layer 11 and connected respectively to the second capacitors C2. Incidentally, the second electrode sections 130 and the second capacitors C2 are connected to the second detection section 25 via the second multiplexer M2.

### (2) Multiplexer

The first multiplexer M1 is a device configured to select one first electrode section 120 from the plurality of first electrode sections 120 and to connect the selected first electrode section 120 to the first detection section 20. The second multiplexer M2 is a device configured to select one second electrode section 130 from the plurality of second electrode sections 130 and to connect the selected second electrode section 130 to the second detection section 25.

Incidentally, the above-described switching of the first electrode sections 120 can be realized by execution by a CPU of a program stored in a storage section such as a microcomputer or a custom IC, etc.

### (3) Detection Section

The first detection section 20 includes a first amplifier section 21 and a second potential detection section 22. The second detection section 25 includes a second amplifier section 26 and a second potential detection section 28. As these configurations are identical to those described above, so explanation thereof will be omitted.

### (4) Effects

With the above-described configuration of the present invention, in the pressure detection device 1, the first electrode sections 120 are connected to the first capacitors C1 and the second electrode sections 130 are connected to the second capacitors C2. Therefore, electric charge generated in the piezoelectric layer 11 is stored in the first capacitors C1 and the second capacitors C2 via the first electrode sections 120 and the second electrode sections 130, respectively.

With the above, even when electric charge generated when the piezoelectric layer 11 is pressed is small, the voltage of the first capacitor C1 or the voltage of the second capacitor C2 can be detected by the first detection section 20 or the second detection section 25, so that the electric charge generated from the piezoelectric layer 11 can be detected by the first detection section 20 or the second detection section 25.

Moreover, the first detection section 20 includes the first amplifier section 21 and the first potential detection section 22. And, the second detection section 25 includes the second amplifier section 26 and the second potential detection section 28. Therefore, even if the voltage of the first capacitor C1 or the voltage of the second capacitor C2 is small, after this voltage is amplified by the first amplifier section 21 or the second amplifier section 26, this can be detected by the first potential detection section 22 or the second potential detection section 28.

Further, the first electrode 12 includes a plurality of first electrode sections 120 which are disposed parallel with the Y-axis direction. Also, the first electrode sections 120 are connected to the first detection section 20 via the first multiplexer M1.

Therefore, which one of the plurality of first electrode sections 120 the electric charge detected by the first detection section 20 has passed can be detected by the first multiplexer M1. Consequently, respecting a load applied to the piezoelectric sensor 10, position of the load in the Y-axis direction can be specified.

Further, the second electrode 13 includes a plurality of second electrode sections 130 which are disposed parallel with the X-axis direction perpendicular to the Y-axis direction. Also, the second electrode sections 130 are connected to the second multiplexer M2.

Therefore, which one of the plurality of second electrode sections 130 the electric charge detected by the second detection section 25 has passed can be detected by the second multiplexer M2. Consequently, respecting a load applied to the piezoelectric sensor 10, position of the load in the X-axis direction can be specified.

Accordingly, with combining the detection results obtained by the first multiplexer M1 and the second multiplexer M2, the position of the load applied to the piezoelectric sensor 10 can be detected. Incidentally, the same as above applies also to a case when there exist a plurality of load applied positions. That is, the above-described pressure detection device 1 allows multiple-force detection.

### (5) Variation

As shown in FIG. 6, in the pressure detection device 1, the first detection section 20 may include a first band-pass filter 23. This first band-pass filter 23 is disposed between the first amplifier section 21 and the first potential detection section 22.

Further, the second detection section 25 can include a second band-pass filter 27. This second band-pass filter 27 is disposed between the second amplifier section 26 and the second potential detection section 28. The first band-pass filter 23 and the second band-pass filter 27 respectively can be comprised of an RLC circuit which passes only frequency of a required range.

Incidentally, a frequency f1 of the first band-pass filter 23 is set as: 1/(T1×2). Where, the invariable: T1 denotes a period from connecting the first detection section 20 to one first electrode section 120 to connecting the same to another first electrode section 120 by the first multiplexer M1.

Further, a frequency f2 of the second band-pass filter 27 is set as: it (T2 2). Where, the invariable: T2 denotes a period from connecting the second detection section 25 to one second electrode section 130 to connecting the same to another first electrode section 130 by the second multiplexer M2.

With the above-described configuration of the first detection section 20, as the first electrode sections 120 to be connected to the first detection section 20 are switched one after another in association with an operation of the first multiplexer M1, the voltage detected by the first potential detection section 22 will vary over time. In this voltage variation, the component of the frequency f1 (f1=1/(T1×2)) contains much voltage information of each first capacitor C1, whereas the other frequency component contains much noise. Here, this noise means such noise which can be received from the electromagnetic wave present around the piezoelectric sensor 10. Therefore, with detection of the frequency f1 alone by the first band-pass filter 23, noise can be removed effectively.

With the above-described configuration of the second detection section 25, as the second electrode sections 130 to be connected to the second detection section 25 are switched one after another in association with an operation of the second multiplexer M2, the voltage detected by the second potential detection section 28 will vary over time. In this voltage variation, the component of the frequency f2 (f2=1/(T2×2)) contains much voltage information of each second capacitor C2, whereas the other frequency component contains much noise. Here, this noise means such noise which can be received from the electromagnetic wave present around the piezoelectric sensor 10. Therefore, with detection of the frequency f2 alone by the second band-pass filter 27, noise can be removed effectively.

### 4. Fourth Embodiment

In the first through third embodiments described above, there have been explained configurations comprising capacitors. Instead of capacitors, resonant circuits can be provided.

### (1) General Configuration of Pressure Detection Device

With reference to FIG. 7, there will be explained a general configuration of a pressure detection device relating to a fourth embodiment of the present invention. FIG. 7 is a schematic showing of a pressure detection device.

The pressure detection device has a function of detecting an amount and a position of a load applied thereto.

As shown in FIG. 7, the pressure detection device 1 relating to the fourth embodiment includes a piezoelectric sensor 10, a first detection section 20 and a first resonant circuit RC1. The piezoelectric sensor 10 includes a piezoelectric layer 11, a first electrode 12 and a second electrode 13. The first electrode 12 is disposed on a first main face of the piezoelectric layer 11 and is electrically connected to the first detection section 20 via the first resonant circuit RC1. The second electrode 13 is disposed on a second main face of the piezoelectric sheet 11 opposite the first main face and is electrically connected to a ground E. Incidentally, the first electrode 12 and the second electrode 13 are respectively disposed on the entire face of the piezoelectric layer 11. Next, features of the pressure detection device 1 will be explained in details.

### (2) Piezoelectric Sensor

The piezoelectric sensor 10 is a device configured to generate an electric charge according to a load applied thereto. As shown in FIG. 7, the piezoelectric sensor 10 includes the piezoelectric layer 11, the first electrode 12 and the second electrode 13.

### (3) Piezoelectric Layer

As some examples of material forming the piezoelectric layer 11, an inorganic piezoelectric material and an organic piezoelectric material can be cited.

As some examples of the inorganic piezoelectric material, barium titanate, lead titanate, lead zirconate titanate, potassium niobate, lithium niobate, lithium tantalate, etc. can be cited.

As some examples of the organic piezoelectric material, fluoride polymers or copolymers thereof, polymer materials having chirality, etc. can be cited. As some examples of fluoride polymers or copolymers thereof, polyvinylidene fluoride, vinylidene fluoride-tetrafluoroetheylene copolymer, vinylidene fluoride-trifluoroethylene copolymer, etc. can be cited. As some examples of polymer material having chirality, L-polylactic acid, RC-polylactic acid, etc. can be cited.

Further, in case the pressure detection device 1 is to be applied to a display device including a touch panel, it is preferred that the piezoelectric sheet be formed of a transparent material or be formed thin to enable sufficient light transmission therethrough.

### (4) Electrodes

The first electrode 12 and the second electrode 13 as described above can be formed of a material having electric conductivity. As some examples of material having electric conductivity, transparent conductive oxidized materials such as indium-tin-oxide (ITO), tin-zinc-oxide (TZO), conductive polymers such as polyethylenedioxy Thiophene (PEDOT), etc. can be used. In this case, the above-described electrodes can be formed with using vapor deposition, screen printing, etc.

Further, as material having conductivity, conductive metal such as copper, silver, etc. can be employed also. In this case, the above-described electrodes can be formed with using vapor deposition or using metal paste such as copper paste, silver paste, etc.

Further, as material having conductivity, it is possible to employ conductive material such as carbon nanotube, metal particles, metal nanofibers, etc. dispersed in a binder.

### (5) Resonant Circuit

The first resonant circuit RC1 is an electric circuit configured to generate a phenomenon of vibration or resonance in response to energy applied from the outside and is comprised of an RLC circuit or an LC circuit. Incidentally, the first resonant circuit RC1 include a variable capacitance diode.

### (6) Detection Section

The first detection section 20 is a device configured to detect variation in the frequency of the first resonant circuit RC1. That is, the first detection section 20 detects variation in the resonant frequency of the first resonant circuit RC1.

With the above-described configuration of the pressure detection device 1, as the first electrode 12 is connected to the first resonant circuit RC1, electric charge generated in the piezoelectric layer 11 flows into the first resonant circuit RC1 via the first electrode 12. Then, in response to input of this electric charge, a bias voltage is applied to the variable capacitance diode, thereby to vary the frequency of the first resonant circuit RC1. As a result, even if the electric charge generated when the piezoelectric layer 11 is pressed is small, this electric charge can be readily detected through detection of change in the first resonant circuit RC1 by the first detection unit 20.

### 5. Fifth Embodiment

Next, a fifth embodiment of the present invention will be described. As its basic configuration is identical to that of the fourth embodiment, only differences thereof will be explained.

### (1) General Configuration of Pressure Detection Device

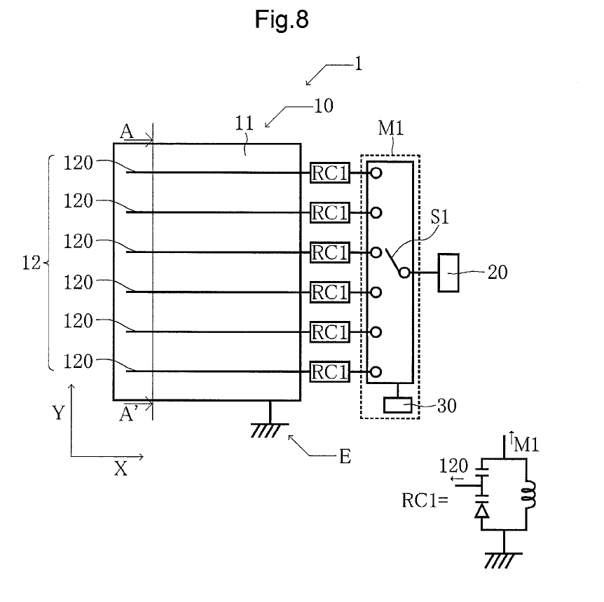

With reference to FIG. 8, a general configuration of a pressure detection device according to a fifth embodiment of the present invention will be described. FIG. 8 is a schematic showing the pressure detection device. A-A′ section in FIG. 8 is same as FIG. 3 shown in “2. Second Embodiment”.

As shown in FIG. 8, the pressure detection device 1 includes a piezoelectric sensor 10, a first detection section 20, a first resonant circuit RC1, and a first multiplexer M1.

As shown in FIG. 3, the piezoelectric sensor 10 includes a piezoelectric layer 11, a first electrode 12 and a second electrode 13. The first electrode 12 is disposed on a first main face of the piezoelectric layer 11 and includes a plurality of first electrode sections 120. The first electrode sections 120 are disposed parallel with the Y-axis direction of the piezoelectric layer 11, with each section 120 being connected to the first resonant circuit RC1. Incidentally, the first electrode 12 and the first resonant circuit RC1 are connected to the first detection section 20 via the first multiplexer M1.

The second electrode 13 is disposed on a second main face of the piezoelectric layer 11 opposite the first main face and this second electrode 13 is disposed on entire face of the second main face and is connected to the ground E (not shown).

### (2) Multiplexer

The first multiplexer M1 is a device configured to receive a plurality of inputs and to output a single signal. Specifically, the first multiplexer M1 selects one first electrode section 120 from the plurality of first electrode sections 120 and connects the selected first electrode section 120 to the first detection section 20.

Incidentally, the above-described switching of the first electrode sections 120 can be realized by execution by a CPU of a program stored in a storage section such as a microcomputer or a custom IC, etc.

With the above-described configuration of the pressure detection device 1, since the first electrode section 120 is connected to the first resonant circuit RC1, electric charge generated in the piezoelectric layer 11 flows into the first resonant circuit RC1 via the first electrode section 120. Then, in response to input of this electric charge, a bias voltage is applied to the variable capacitance diode, thereby to vary the frequency of the first resonant circuit RC1. As a result, even if the electric charge generated when the piezoelectric layer 11 is pressed is small, this electric charge can be readily detected through detection of change in the first resonant circuit RC1 by the first detection unit 20.

Further, there are provided a plurality of first electrode sections 120 which are disposed parallel with the Y-axis direction. Also, the first electrode sections 120 are connected to the first detection section 20 via the first multiplexer M1.

Therefore, which one of the plurality of first electrode sections 120 the electric charge detected by the first detection section 20 has passed can be detected by the first multiplexer M1. Consequently, respecting a load applied to the piezoelectric sensor 10, position of the load in the X-axis direction can be specified.

### 6. Sixth Embodiment

Next, a sixth embodiment of the present invention will be described. As its basic configuration is identical to that of the fourth and fifth embodiments, only differences thereof will be explained.

### (1) General Configuration of Pressure Detection Device

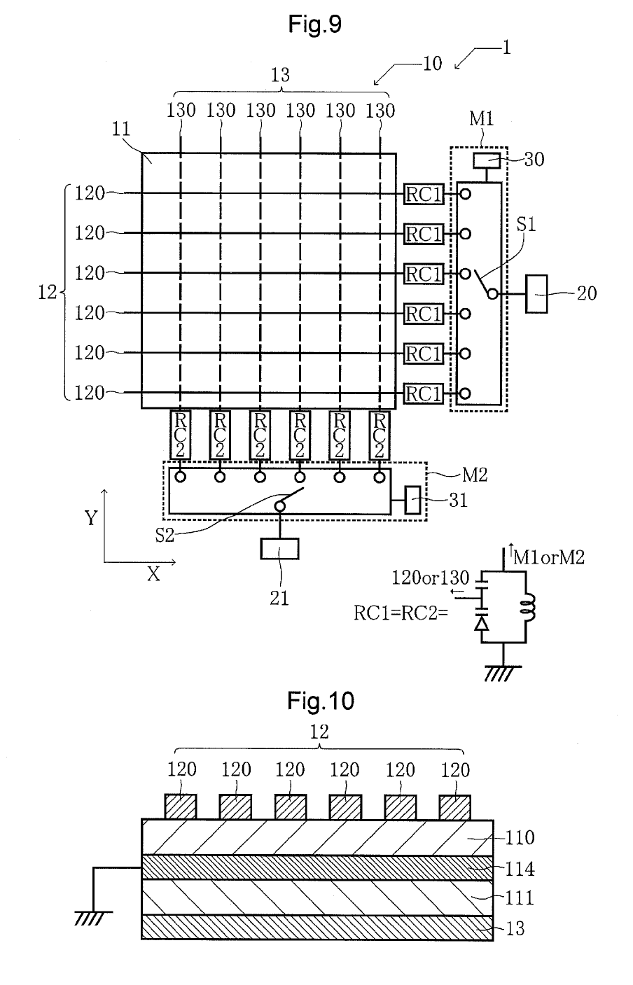

With reference to FIG. 9, a general configuration of a pressure detection device according to a sixth embodiment of the present invention will be described. FIG. 9 is a schematic showing the pressure detection device.

As shown in FIG. 9, the pressure detection device 1 according to the sixth embodiment includes a piezoelectric sensor 10, a first detection section 20, a second detection section 21, a first resonant circuit RC1, a second resonant circuit RC2, a first multiplexer M1 and a second multiplexer M2.

The piezoelectric sensor 10 includes a piezoelectric layer 11, a first electrode 12 and a second electrode 13. The first electrode 12 is disposed on a first main face of the piezoelectric layer 11 and includes a plurality of first electrode sections 120. The first electrode sections 120 are disposed parallel with the Y-axis direction of the piezoelectric layer 11, with each section 120 being connected to the first resonant circuit RC1. Incidentally, the first electrode sections 120 and the first resonant circuits RC1 are connected to the first detection section 20 via the first multiplexer M1.

The second electrode 13 is disposed on a second main face of the piezoelectric layer 11 opposite the first main face and includes a plurality of second electrode sections 130. The second electrode sections 130 are disposed parallel with the X-axis direction of the piezoelectric layer 11, with each section 130 being connected to the second resonant circuit RC2. Incidentally, the second electrode sections 130 and the second resonant circuits RC2 are connected to the second detection section 31 via the second multiplexer M2.

### (2) Multiplexer

The first multiplexer M1, the second multiplexer M2 respectively is a device configured to receive a plurality of inputs and to output a single signal. The first multiplexer M1 selects one first electrode section 120 from the plurality of first electrode sections 120 and connects the selected first electrode section 120 to the first detection section 20. The second multiplexer M2 selects one second electrode section 130 from the plurality of second electrode sections 130 and connects the selected second electrode section 130 to the second detection section 25.

### (3) Detection Section

The first detection section 20 and the second detection section 21 respectively is a device configured to detect variation in the frequency of the first resonant circuit RC1 and the second resonant circuit RC2. That is, the first detection section 20 and the second detection section 25 respectively detects variation in the resonant frequency of the first resonant circuit RC1 and the second resonant circuit RC2 when the electric charge flows in the first resonant circuit RC1 and the second resonant circuit RC2.

### (4) Resonant Circuit

The first resonant circuit RC1 and the second resonant circuit RC2 respectively is an electric circuit configured to generate a phenomenon of vibration or resonance in response to energy applied from the outside and is comprised of an RLC circuit or an LC circuit. Incidentally, preferably the first resonant circuit RC1 and the second resonant circuit RC2 respectively include a variable capacitance diode.

With the above-described configuration of the pressure detection device 1, the first electrode sections 120 are connected to the first resonant circuit RC1 and the second electrode sections 130 are connected to the second resonant circuit RC2. Therefore, electric charge generated in the piezoelectric layer 11 flows into the first resonant circuit RC1 via the first electrode sections 120 or into the second resonant circuit RC2 via the second electrode sections 130. Then, in response to input of this electric charge, a bias voltage is applied to the variable capacitance diode, thereby to vary the frequency of the first resonant circuit RC1 or the second resonant circuit RC2.

As a result, even if the electric charge generated when the piezoelectric layer 11 is pressed is small, this electric charge can be readily detected.

Further, the first electrode 12 includes the plurality of first electrode sections 120 disposed parallel with the Y-axis direction and the first electrode sections 120 are connected to the first multiplexer M1.

Therefore, which one of the plurality of first electrode sections 120 the electric charge detected by the first detection section 20 has passed can be detected by the first multiplexer M1. Consequently, respecting a load applied to the piezoelectric sensor 10, position of the load in the X-axis direction can be specified.

Further, the second electrode 13 includes the plurality of second electrode sections 130 disposed parallel with the X-axis direction perpendicular to the Y-axis direction and the second electrode sections 130 are connected to the second multiplexer M2.

Therefore, which one of the plurality of second electrode sections 130 the electric charge detected by the second detection section 21 has passed can be detected by the second multiplexer M2. Consequently, respecting a load applied to the piezoelectric sensor 10, position of the load in the Y-axis direction can be specified.

Accordingly, with combining the detection results obtained by the first multiplexer M1 and the second multiplexer M2, the position of the load applied to the piezoelectric sensor 10 can be detected. Incidentally, the same as above applies also to a case when there exist a plurality of load applied positions. That is, the above-described pressure detection device 1 allows multiple-force detection.

### 7. Seventh Embodiment

In the first through sixth embodiments, there have been explained the configuration in which the piezoelectric layer 11 is sandwiched between the first electrode 12 and the second electrode 13. Instead, a reference electrode 114 can be disposed between the first electrode 12 and the second electrode 13.

FIG. 10 is a section view showing a piezoelectric sensor according to a seventh embodiment.

As shown in FIG. 10, in the piezoelectric sensor 10 according to the seventh embodiment, a reference electrode 114 is provided between the first electrode 12 and the second electrode 13. And, between the first electrode 12 and the reference electrode 114, a first piezoelectric layer 110 is provided. And, between the second electrode 13 and the reference electrode 114, a second piezoelectric layer 111 is provided. Material of the first piezoelectric sheet 110 and the second piezoelectric sheet 111 is same as the material of the piezoelectric layer 11. Also, material of the reference electrode 114 is same as the material of the first electrode 12 and the second electrode 13.

In this way, with provision of the reference electrode 40 between the first electrode 12 and the second electrode 13, it is possible to detect electric charge generated in the first piezoelectric sheet 110 or the second piezoelectric sheet 111, by the first electrode 12 and the second electrode 13 independently of each other. As a result, designing of the detection circuit becomes simple.

### 8. Other Embodiments

In the above, there has been explained an example of detecting position and amount of applied load by the piezoelectric sensor 10. Instead, detection of position and amount of applied load is also possible by superposing a touch panel 50 on the piezoelectric sensor 10.

With such superposing of the touch panel 50 on the piezoelectric sensor 10, even when the applied load is too small to be detected by the piezoelectric sensor 10 (in the case of “feather touch”), the position of the applied load can be detected with use of the touch panel 50.

### DESCRIPTION OF REFERENCE MARKS/NUMERALS

1: pressure detection device
10: piezoelectric sensor
11: piezoelectric layer
12: first electrode
13: second electrode
20: first detection section
C1: first capacitor
RC1: first resonant circuit

1.-14. (canceled)

15. A pressure detection device comprising:
a piezoelectric layer that generates an electric charge when pressed by an inputting means;
a first electrode that is arranged on a first main face of the piezoelectric layer;
a first capacitor connected to the first electrode;
a first multiplexer connected to the first electrode and the first capacitor;
a first detection section connected to the first multiplexer;
a second electrode that is arranged on a second main face of the piezoelectric layer opposite the first main face;
a second capacitor connected to the second electrode;
a second multiplexer connected to the second electrode and the second capacitor;
a second detection section connected to the second multiplexer;
wherein the first electrode includes a plurality of first electrode sections connected to the first capacitor;
the first multiplexer is configured to selectively connect the plurality of the first electrode sections to the first detection section;
wherein the second electrode includes a plurality of second electrode sections connected to the second capacitor;
the second multiplexer is configured to selectively connect the plurality of the second electrode sections to the second detection section; and
the first detection section includes:
a first amplifier section connected to the first multiplexer;
a first voltage detector connected to the first amplifier section; and
a first band-pass filter connected between the first amplifier section and the first voltage detector and having a frequency (f1) represented by a following formula (1),
f1=1/(T1×2) formula (1)
where T1=a period required from connection of the first detection section to one first electrode section to connection thereof to another first electrode section.

16. An input device comprising the pressure detection device according to claim 15 and a touch panel.

17. The pressure detection device according to claim 15, wherein:
the first electrode sections are disposed in a direction parallel with one direction; and
the second electrode sections are disposed in a direction intersecting the one direction.

18. An input device comprising the pressure detection device according to claim 17 and a touch panel.

19. A pressure detection device comprising:
a piezoelectric layer that generates an electric charge when pressed by an inputting means;
a first electrode that is arranged on a first main face of the piezoelectric layer;
a first capacitor connected to the first electrode;
a first multiplexer connected to the first electrode and the first capacitor;
a first detection section connected to the first multiplexer;
a second electrode that is arranged on a second main face of the piezoelectric layer opposite the first main face;
a second capacitor connected to the second electrode;
a second multiplexer connected to the second electrode and the second capacitor;
a second detection section connected to the second multiplexer;
wherein the first electrode includes a plurality of first electrode sections connected to the first capacitor;
the first multiplexer is configured to selectively connect the plurality of the first electrode sections to the first detection section;
wherein the second electrode includes a plurality of second electrode sections connected to the second capacitor;
the second multiplexer is configured to selectively connect the plurality of the second electrode sections to the second detection section; and
the second detection section includes:
a second amplifier section connected to the second multiplexer;
a second voltage detector connected to the second amplifier section; and
a second band-pass filter connected between the second amplifier section and the second voltage detector and having a frequency (f2) represented by a following formula (2),
f2=1/(T2×2) formula (2)
where T2=a period required from connection of the second detection section to one second electrode section to connection thereof to another second electrode section.

20. An input device comprising the pressure detection device according to claim 19 and a touch panel.

21. The pressure detection device according to claim 19, wherein:
the first electrode sections are disposed in a direction parallel with one direction; and
the second electrode sections are disposed in a direction intersecting the one direction.

22. An input device comprising the pressure detection device according to claim 21 and a touch panel.
